(19) United States
(12) Patent Application Publication
(10) Pub. No.: US 2025/0038332 A1
(43) Pub. Date: Jan. 30, 2025

(54) BATTERY PACK FRAME ASSEMBLIES

(71) Applicant: Toyota Motor Engineering & Manufacturing North America, Inc., Plano, TX (US)

(72) Inventors: Ryan C. Harris, Saline, MI (US); Todd Muck, Fowlerville, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/225,857

(22) Filed: Jul. 25, 2023

(51) Int. Cl. H01M 50/242; H01M 50/262; H01M 50/291

(52) U.S. Cl. CPC H01M 50/242; H01M 50/262; H01M 50/291; H01M 50/209; H01M 2220/20

(57) ABSTRACT

A battery pack frame is disclosed. A battery pack frame includes a front wall, a rear wall, a pair of sidewalls extending between the front wall and the rear wall, and a bottom plate extending beneath the front wall, the rear wall, and the pair of sidewalls. A plurality of cross members extend between the pair of sidewalls, and each of the plurality of cross members includes an extruded frame having at least one channel that defines a cavity and a reinforcement member positioned within the at least one cavity.

### TECHNICAL FIELD

The present specification generally relates to battery pack frame assemblies and, more specifically, to battery pack frame assemblies having internal cross members with an internal reinforcement.

### BACKGROUND

Traditional vehicular battery pack frame assemblies may contain internal cross members that are used to distribute a crash load and protect battery modules during a crash event. In many cases, these cross members are made of extruded aluminum or cold rolled steel. However, these structures are often heavy and difficult to manufacture. Accordingly, a need exists for battery pack frame assemblies that are able to distribute a crash load while reducing weight and being easy to manufacture.

### SUMMARY

In one embodiment, a battery pack frame is disclosed. The battery pack frame includes a front wall, a rear wall, a pair of sidewalls extending between the front wall and the rear wall, and a bottom plate extending beneath the front wall, the rear wall, and the pair of sidewalls. A plurality of cross members extend between the pair of sidewalls, and each of the plurality of cross members includes an extruded frame having at least one channel that defines a cavity and a reinforcement member positioned within the at least one cavity.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a battery pack frame, according to one or more embodiments described and illustrated herein;

FIG. 2A schematically depicts a partial cross-sectional view of an embodiment of the battery pack frame taken along line II-II of FIG. 1, according to one or more embodiments described and illustrated herein;

FIG. 2B schematically depicts a partial cross-sectional view of another embodiment of the battery pack frame taken along line II-II of FIG. 1, according to one or more embodiments described and illustrated herein;

FIG. 3A schematically depicts a partial cross-sectional view of still another embodiment of the battery pack frame taken along line II-II of FIG. 1, according to one or more embodiments described and illustrated herein; and

FIG. 3B schematically depicts a partial cross-sectional view of still another embodiment of the battery pack frame taken along line II-II of FIG. 1, according to one or more embodiments described and illustrated herein;

### DETAILED DESCRIPTION

Embodiments described herein are generally directed to vehicular battery pack frame assemblies having a plurality of cross members that each include an extruded frame and a reinforcement member positioned within the extruded frame. The reinforcement members may provide additional rigidity to plurality of cross members, such that, in the event of a crash, the crash load is more evenly distributed between across the plurality of cross members of the battery pack frame. In embodiments, a foam material and/or a fastener may be utilized to secure the reinforcement member within the extruded frame of each of the plurality of cross members, and may further act to provide additional rigidity to the battery pack frame.

As will be described in additional detail herein, the battery pack frame assemblies include a front wall, a rear wall, a pair of sidewalls extending between the front wall and the rear wall, and a bottom plate extending beneath the front wall, the rear wall, and the pair of sidewalls. A plurality of cross members extend between the pair of sidewalls, and each of the plurality of cross members includes an extruded frame having at least one channel that defines a cavity and a reinforcement member positioned within the at least one cavity.

Various embodiments of battery pack frame assemblies are described in detail below. Whenever possible, the same reference numerals will be used throughout the drawings to refer to the same or like parts. As used herein, the term “vehicle longitudinal direction” refers to the forward-rearward direction of the vehicle (i.e., in the +/−vehicle X-direction as depicted). The term “vehicle lateral direction” refers to the cross-vehicle direction of the vehicle (i.e., in the +/−vehicle Z-direction as depicted), and is transverse to the vehicle longitudinal direction. The term “vehicle vertical direction” refers to the upward-downward direction of the vehicle (i.e., in the +/−vehicle Y-direction as depicted). Further, the terms “upward.” “downward,” “rearward,” and “forward” are used to describe the relative positioning of various components of the vehicle relative to one another. Because the vehicle structures may be generally symmetrical about the vehicle centerline, the terms “upward,” “downward.” “rearward,” and “forward” may be switched when evaluating components positioned along opposite sides of the vehicle. Further, while certain components of the vehicle are described as extending in one of the identified directions or oriented toward one of the identified directions, it should be understood that these components extend or are oriented in at least these recited directions.

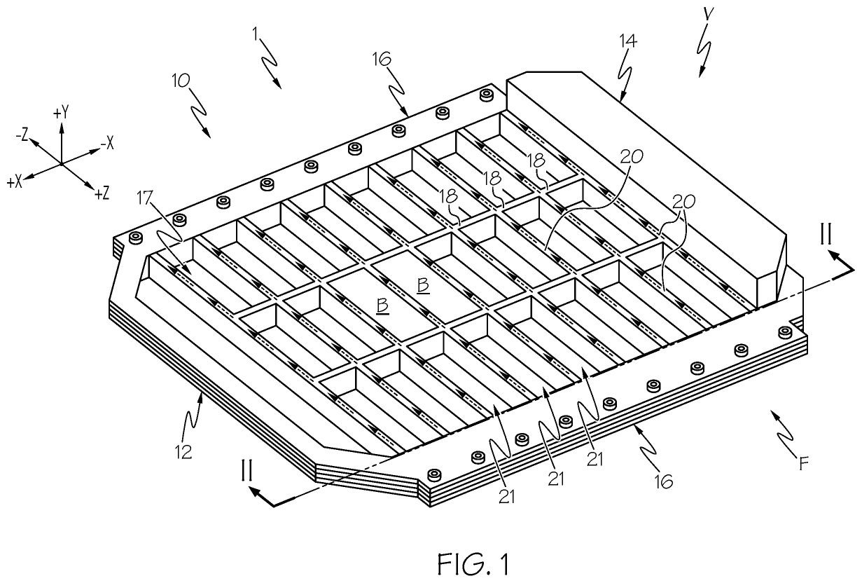

Referring now to FIG. 1, a vehicle V having a battery pack frame assembly 1 is illustrated. As illustrated in FIG. 1, the battery pack frame assembly 1 may include a battery pack frame 10 and a plurality of batteries B disposed within the battery pack frame 10. The battery pack frame 10 may include a front wall 12, a rear wall 14, and a pair of sidewalls 16 that extend between ends of the front wall 12 and the rear wall 14. The battery pack frame 10 may further include a bottom plate 17 that extends between and beneath (e.g., in the −y-direction as depicted in the coordinate axis of FIG. 1) the front wall 12, rear wall 14, and the pair of sidewalls 16. In some embodiments, the bottom plate 17 may be a cooling plate or other similar mechanism capable of cooling the plurality of batteries B disposed within the battery pack frame assembly 1.

As further depicted in FIG. 1, the front wall 12 is arranged frontward of the rear wall 14, but it should be understood that the front wall 12 and the rear wall 14 may similarly be arranged in a reversed orientation without departing from the scope of the present disclosure. In these embodiments, the front wall 12, the rear wall 14, and the pair of sidewalls 16 may be formed of aluminum, steel (e.g., cold rolled steel) or any similar material.

The battery pack frame 10 further includes a plurality of longitudinal intermediate cross members 18 and a plurality of cross members 20, such as a plurality of traverse intermediate cross members. The plurality of longitudinal intermediate cross members 18 extend between the front wall 12 and the rear wall 14. The plurality of cross members 20 extend between the pair of sidewalls 16. The plurality of longitudinal intermediate cross members 18 intersect with the plurality of cross members 20 to form cavities 21 that receive the batteries B of the battery pack frame assembly 1.

In operation, the battery pack frame assembly 1 allows for a force F, such as a vehicular side crash load, to be transferred from an exterior side of one of the pair of sidewalls 16 to the other of the pair of sidewalls 16 via the plurality of cross members 20. For example, as depicted in FIG. 1, when the force F is applied to one of the sidewalls 16, the force F may be transferred in the vehicle lateral direction (e.g. in the −z-direction as depicted in the coordinate axis of FIG. 1) from the one sidewall 16 receiving the force F to the opposing sidewall 16 via the plurality of cross members 20. By transferring the force F between the pair of sidewalls 16, the force F may be more evenly distributed across the battery pack frame 10, and deformations within the battery pack frame 10 may be minimized such that the plurality of batteries B may remain secured within the battery pack frame 10.

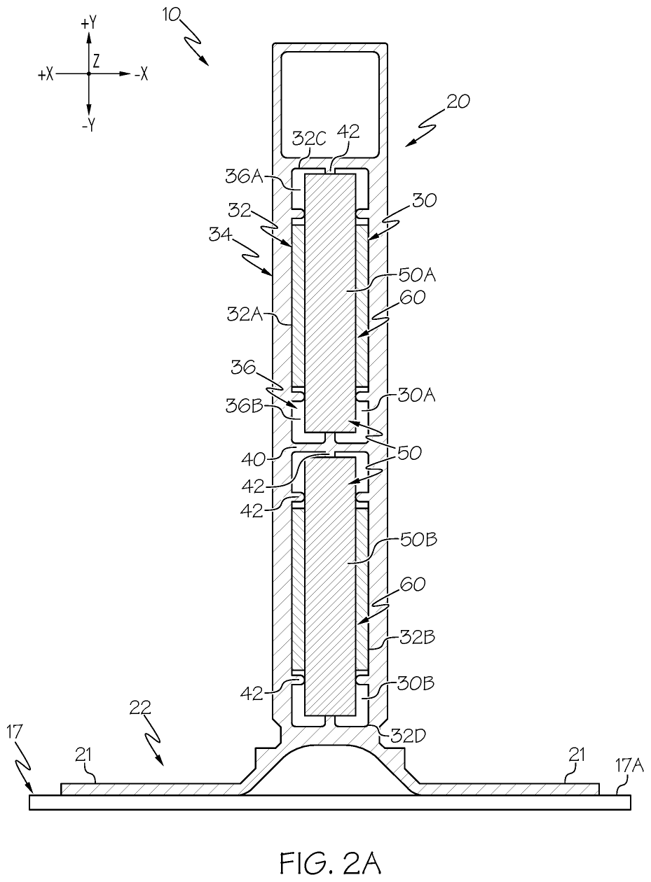

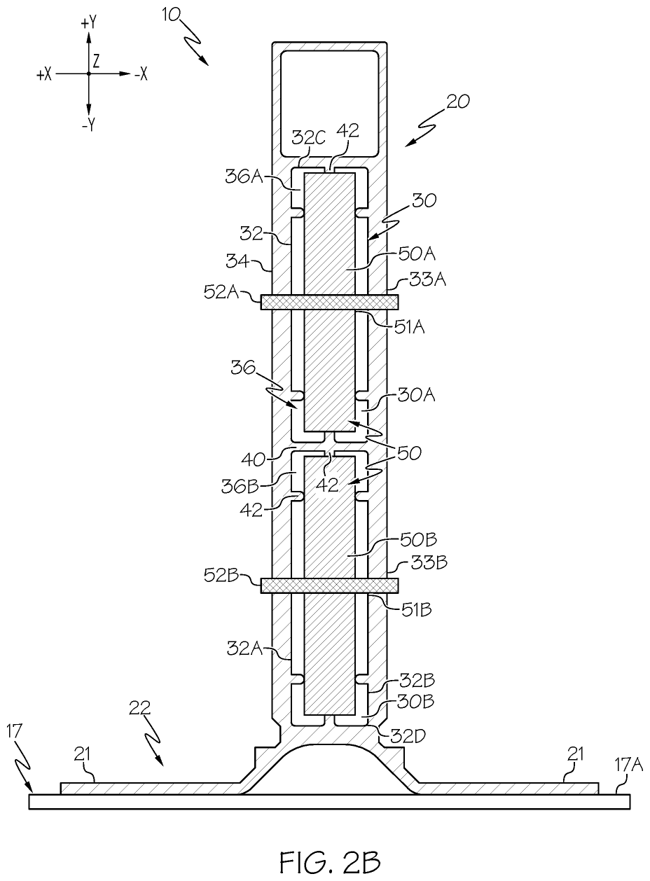

Referring now to FIGS. 2A and 2B, each of the plurality of cross members 20 may include a frame 22, such as an extruded frame, that secures each of the plurality of cross members 20 to the battery pack frame 10. For example, the frame 22 may be fixedly coupled (e.g., via welding, etc.) to the bottom plate 17 of the battery pack frame 10 to secure each of the plurality of cross members 20 within the battery pack frame 10. In these embodiments, the frame 22 includes flanges 21 that are fixedly secured to an upper surface 17a of the bottom plate 17. It should be further noted that, in embodiments, the frame 22 may be formed of aluminum, steel (e.g., cold rolled and/or stainless steel), magnesium alloys, carbon fiber reinforced polymers, and/or any other similar materials without departing from the scope of the present disclosure.

As further depicted in FIGS. 2A and 2B, each of the plurality of cross members 20 may include at least one channel 30 that extends along a length of the frame 22 (e.g., in the +/−z-direction as depicted in the coordinate axes of FIGS. 2A and 2B). In these embodiments, the channel 30 may include a plurality of interior surfaces 32 that define a cavity 36 and a plurality of exterior surfaces 34. For example, as depicted in FIGS. 2A and 2B, the channel 30 may include a first interior surface 32A, a second interior surface 32B positioned opposite the first interior surface 32A, a third interior surface 32C positioned adjacent the first interior surface 32A and the second interior surface 32B, and a fourth interior surface 32D positioned opposite the third interior surface 32C. Accordingly, it should be appreciated that the cavity 36 defined by the interior surfaces 32 depicted in FIGS. 2A and 2B may have a generally rectangular shape.

Although the channel 30 depicted in FIGS. 2A and 2B includes four interior surfaces 32A-32D, it should be appreciated that the channel 30 may include any number of interior surfaces 32 without departing from the scope of the present disclosure. For example, the channel 30 may include three interior surfaces, four interior surfaces, five interior surfaces, or any other number of interior surfaces 32. Furthermore, it should be appreciated that, in these embodiments, the number of interior surfaces 32 of the channel 30 may determine the shape of the corresponding cavity 36. For example, a channel having three interior surfaces may define a cavity having a generally triangular shape, while a channel having six interior surfaces may define a cavity having a generally hexagonal shape.

Referring still to FIGS. 2A and 2B, the channel 30 may further include an intermediate wall 40, which may divide the at least one channel 30 into a plurality of channels. For example, as depicted in FIGS. 2A and 2B, the intermediate wall 40 may extend between the first interior surface 32A and the second interior surface 32B of the channel 30, such that the intermediate wall 40 defines an upper channel 30A and a lower channel 30B. In these embodiments, the upper channel 30A may include an upper cavity 36A that may be defined between the first interior surface 32A, the second interior surface 32B, the third interior surface 32C, and the intermediate wall 40. Similarly, the lower channel 30B may define a lower cavity 36B that may be defined between the first interior surface 32A, the second interior surface 32B, the fourth interior surface 32D, and the intermediate wall 40.

Although FIGS. 2A and 2B depict the channel 30 as including a single intermediate wall 40, it should be further appreciated that, in some embodiments, the channel 30 may include a plurality of intermediate walls, with each of the plurality of intermediate walls defining an additional channel. For example, in embodiments in which the channel includes two intermediate walls, the channel may be divided into three channels. Similarly, in embodiments in which the channel includes three intermediate walls, the channel may be divided into four channels. In these embodiments, the channel 30 may include any number of intermediate walls without departing from the scope of the present disclosure.

As further depicted in FIGS. 2A and 2B, each of the plurality of cross members 20 may further include a reinforcement member 50 positioned within the at least one cavity 36. In these embodiments, the reinforcement member 50 may be a composite pultrusion reinforcement member, or any other similar member capable of increasing the structural rigidity of each of the plurality of cross members 20. For example, the reinforcement member 50 may be formed of a continuous fiber reinforced resin material and/or a resin composite material and one or more fibers extending in one direction. As a non-limiting example, the one or more fibers may be glass fibers such as continuous glass fibers. As another non-limiting example, the one or more fibers may be glass fibers and nylon fibers (e.g., 95% of the one or more fibers are glass fibers, and 5% of the one or more fibers are nylon fibers). The one or more fibers may be configured to reinforce the resin composite material (e.g., resins such as epoxy, polyester, etc.) of the reinforcement member 50. As such, the glass fibers may increase a tensile strength, flex modulus, impact resistance, and dimensional stability of the reinforcement member 50. In further embodiments, the reinforcement member 50 is formed of a continuous glass fiber reinforced resin material.

In the embodiments described herein, the reinforcement member 50 may be formed using a continuous molding pultrusion process in which the reinforcing fibers, such as long strand glass-fibers, are saturated with a liquid resin material, such as a liquid polymer resin, then pulled through a heated forming die to create the reinforcement member 50. In some embodiments, pigments and catalysts that enhance the curing of the reinforcement member 50 may be added while the one or more continuous glass fibers are saturated with the liquid resin material. However, it should be understood that the reinforcement member 50 may be formed using any suitable pultrusion process or other suitable manufacturing process in other embodiments without departing from the scope of the present disclosure.

Referring still to FIGS. 2A and 2B, it should be appreciated that, in some embodiments, each of the plurality of cross members 20 may include a plurality of reinforcement members 50, such that each channel 30 defined within the frame 22 of each of the plurality of cross members 20 may receive a reinforcement member 50. For example, as depicted in FIGS. 2A and 2B, the plurality of cross members 20 may include a first reinforcement member 50A positioned within the upper channel 30A and a second reinforcement member 50B positioned within the lower channel 30B.

Although FIGS. 2A and 2B depict the plurality of cross members 20 as including two reinforcement members, it should be appreciated that the plurality of cross members 20 may include any number of reinforcement members 50 without departing from the scope of the present disclosure. Furthermore, although the reinforcement members 50 are depicted as having a generally rectangular shape, it should be appreciated that the reinforcement members 50 may take any shape (e.g., triangular, hexagonal, circular, etc.) without departing from the scope of the present disclosure. It should be further noted that, in some embodiments, each of the channels 30 defined within the frame 22 of the plurality of cross members 20 may not receive a reinforcement member 50. For example, in some embodiments, only one channel (e.g., the upper channel 30A) may receive a reinforcement member 50 while the remaining channels (e.g., lower channel 30B) do not receive a reinforcement member 50.

Referring still to FIGS. 2A and 2B, the channel 30 further may include a plurality of locating ribs 42 that are positioned on and extend from each of the interior surfaces 32A-32D of the channel 30. In these embodiments, the plurality of locating ribs 42 may be integrally formed within the channel 30 and may extend from each of the interior surfaces 32A-32D of the channel 30 and into cavity 36. As further depicted in FIGS. 2A and 2B, at least one of the plurality of ribs 42 may be integrally formed with and may extend from the intermediate wall 40. For example, in the embodiment depicted in FIGS. 2A and 2B, the intermediate wall 40 may include two locating ribs 42, with a first locating rib 42 extending upwardly (e.g., in the +y-direction as depicted in the coordinate axis of FIGS. 2A and 2B) into the upper channel 30A and the second locating rib 42 extending downwardly (e.g., in the −y-direction as depicted in the coordinate axis of FIGS. 2A and 2B) into the lower channel 30B. Accordingly, in the embodiment depicted in FIGS. 2A and 2B, the upper channel 30A and the lower channel 30B may each include a plurality of locating ribs 42. It should be appreciated that, in these embodiments, each channel 30 defined within the frame 22 may include the plurality of locating ribs 42.

As depicted in FIGS. 2A and 2B, the plurality of locating ribs 42 may be used to position the reinforcement members 50 within the channels 30. For example, the first reinforcement member 50A may be inserted into the upper channel 30A such that the first reinforcement member 50A is aligned and/or in contact with the plurality of locating ribs 42. In these embodiments, the plurality of locating ribs 42 may position the reinforcement member 50 such that the reinforcement member 50 is spaced from each of the interior surfaces 32A-32D of the channel 30 and the intermediate wall 40. For example, as depicted in FIGS. 2A and 2B, the plurality of locating ribs 42 extend into the cavity 36 such that, when the first reinforcement member 50A is positioned within the cavity 36, a space exists between the first reinforcement member 50A and the first interior surface 32A, second interior surface 32B, third interior surface 32C, and intermediate wall 40, respectively.

Referring now to FIG. 2A, each of the plurality of cross members 20 may further include a foam material 60, such as an expandable adhesive foam, that may be inserted into the cavity 36 defined by the channel 30 in order to secure the reinforcement member 50 within the channel 30 of the frame 22. In these embodiments, the foam material 60 may be inserted into the vacant space within the cavity 36 of the channel 30 that exists between the reinforcement member 50, the plurality of locating ribs 42, and the interior surfaces 32 of the channel. For example, as depicted in FIG. 2A the foam material 60 may be inserted into the cavity 36 such that the foam material 60 occupies the space between the first reinforcement member 50A, the first interior surface 32A, the second interior surface 32B, and the plurality of locating ribs 42. Although not depicted, it should be further appreciated that, in some embodiments, the foam material 60 may be inserted into the cavity 36 such that the foam material 60 further consumes any empty space within the cavity 36 (e.g., space not occupied by the reinforcement member 50 and/or the plurality of locating ribs 42). In these embodiments, the foam material 60 may be inserted onto the interior surfaces 32 of the channel 30 either before or after the reinforcement member 50 is positioned within the channel 30. Furthermore, it should be understood that, in the embodiments described herein, the foam material 60 may act to retain the reinforcement member 50 in a predetermined position within the channel 30, such that that noise and/or vibration may be reduced by retaining the reinforcement member 50 in the predetermined position.

In the embodiments described herein, a variety of foam material 60 may be utilized within the cavity 36 to secure the reinforcement member 50 within the cavity 36 of the channel 30. In these embodiments, the foam material 60 utilized within the cavity 36 may be determined based on a load distributed across the battery pack frame 10. For example, the density of the foam material 60 utilized within the cavity 36 may be proportional to the load distributed across the battery pack frame 10. In these embodiments, a battery pack frame 10 subjected to a greater load may require a higher density foam material 60 within the cavity 36 to ensure that the reinforcement member 50 remains secured when the load is applied to the battery pack frame 10.

For example, the foam material 60 may include a high energy absorption foam, such as a polyurethane foam. In these embodiments, the foam material 60 may have a density between 0.1-1.0 g/cm³, such as between 0.1-0.7 g/cm³. In other embodiments, the foam material 60 may include a structural foam, such as a polyamide particle foam. In these embodiments, the foam material 60 may have a density between 250-400 g/L, such as between 290-350 g/L. However, it should be understood that the embodiments described herein are intended to be exemplary in nature, and the foam material 60 may include any material of any density without departing from the scope of the present disclosure.

Although not depicted herein, it should be further appreciated that, in some embodiments, a plurality of foam material 60 may be provided within the various channels 30 of each of the plurality of cross members 20. For example, the upper cavity 36A defined by the upper channel 30A may include a first foam having a first density while the lower cavity 36B defined by the lower channel 30B may include a second foam having a second density that is different from the first density of the first foam. In these embodiments, the foam material 60 may be a heat activated foam, such as a heat activated adhesive foam, that expands in size after being heated (e.g., via an external heat source) to above a predetermined temperature in order to allow for the foam material 60 to be inserted within the various channels 30 before the reinforcement member 50 is positioned within the channel 30. It should be further appreciated that the foam material 60 described herein is for illustrative purposes only, and any variety of foam may be used in each of the respective channels 30 without departing from the scope of the present disclosure.

Referring now to FIG. 2B, in some embodiments, the plurality of cross members 20 may further include a fastener 52 to fixedly secure the reinforcement member 50 within the cavity 36 of the channel 30 of each of the plurality of cross members 20. In these embodiments, the channel 30 may further include a channel hole 33 that extends between the interior surfaces 32 (e.g., first and second interior surfaces 32A, 32B) and exterior surfaces 34 (e.g., in the +/−x-direction as depicted in the coordinate axis of FIG. 2B) of the sides of the channel 30. For example, as depicted in FIG. 2B, the upper channel 30A may include an upper channel hole 33A, while the lower channel 30B may include a lower channel hole 33B.

In order to secure the reinforcement member 50 within the channel 30, the reinforcement member 50 may further include a reinforcement hole 51. In these embodiments, the reinforcement hole 51 may extend through a width of the reinforcement member 50 (e.g., in the +/−x-direction as depicted in the coordinate axis of FIG. 2B), such that the reinforcement hole 51 aligns (e.g., in the +/−y-direction as depicted in the coordinate axis of FIG. 2B) with the channel hole 33 when the reinforcement member 50 is inserted into the channel 30. For example, as depicted in FIG. 2B, the first reinforcement member 50A may include a first reinforcement hole 51A that may align with the upper channel hole 33A of the upper channel 30A, while the second reinforcement member 50B may include a second reinforcement hole 51B that may align with the lower channel hole 33B of the lower channel 30B.

With the reinforcement hole 51 and the channel hole 33 aligned, the fastener 52 may be inserted through the channel hole 33 and the reinforcement hole 51 to secure the reinforcement member 50 within the channel 30. In the embodiments described herein, the fastener 52 may include a pin, such as a dowel pin, clevis pin, taper pin, spring pin, hitch pins, grooved pin, or any other similar fastener.

Although not depicted, it should be further appreciated that, in some embodiments, each of the plurality of cross members 20 may include both the foam material 60 and fastener 52. For example, in embodiments in which the reinforcement member 50 of does not fully occupy the cavity 36 defined by the channel 30, the fastener 52 may be inserted through the channel 30 and the reinforcement member 50 while the foam material 60 may be used to fill any remaining vacant space within the cavity 36.

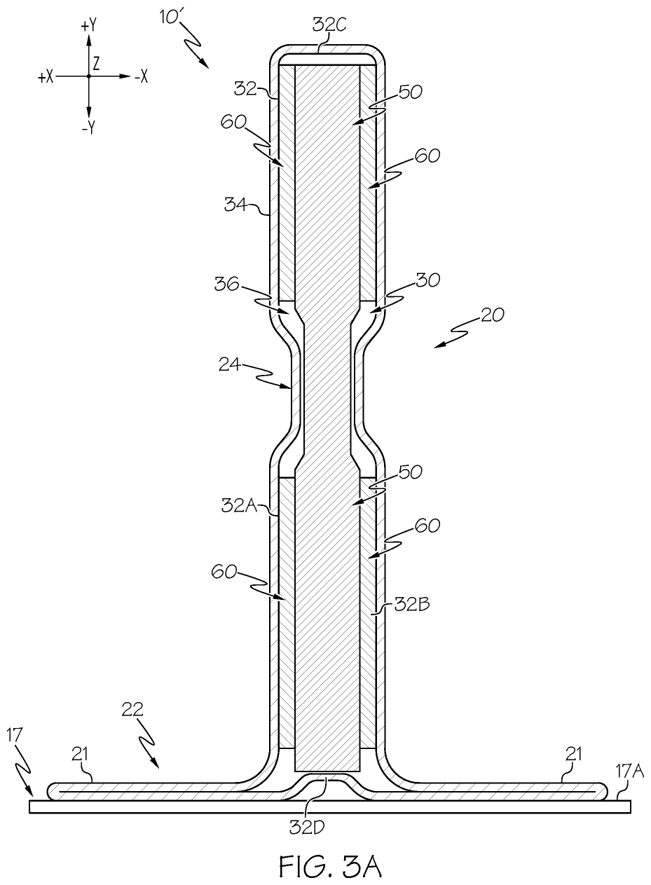

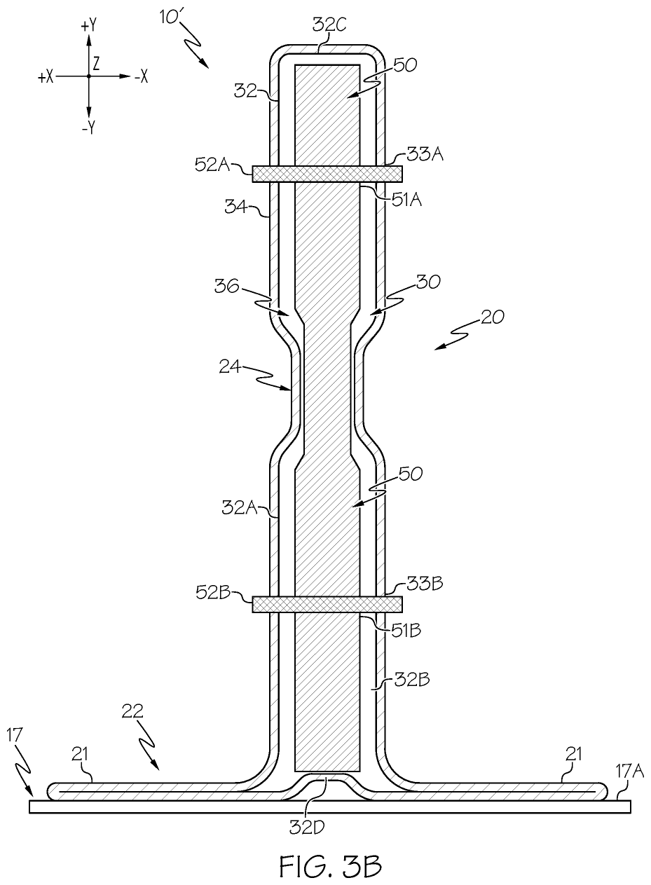

Referring now to FIGS. 3A and 3B, another embodiment of the battery pack frame 10′ is depicted. As the battery pack frame 10′ depicted in FIGS. 3A and 3B is structurally similar to those depicted in FIGS. 2A and 2B, the same reference numbers will be used to refer to like structure where possible.

In the embodiments depicted in FIGS. 3A and 3B, each of the plurality of cross members 20 may include a frame 22, such as an extruded frame, that secures each of the plurality of cross members 20 to the battery pack frame 10′. For example, the frame 22 may be fixedly coupled (e.g., via welding, etc.) to the bottom plate 17 of the battery pack frame 10′ to secure each of the plurality of cross members 20 within the battery pack frame 10′.

As further depicted in FIGS. 3A and 3B, each of the plurality of cross members 20 may include at least one channel 30 that extends along a length of the frame 22 (e.g., in the +/−z-direction as depicted in the coordinate axes of FIGS. 3A and 3B). In these embodiments, the channel 30 may include a plurality of interior surfaces 32 and a plurality of exterior surfaces 34 that define a cavity 36. For example, as depicted in FIGS. 3A and 3B, the channel 30 may include a first interior surface 32A, a second interior surface 32B positioned opposite the first interior surface 32A, a third interior surface 32C positioned adjacent the first interior surface 32A and the second interior surface 32B, and a fourth interior surface 32D positioned opposite the third interior surface 32C.

In these embodiments, the frame 22 may further include a central portion 24 that is tapered relative to the remainder of the frame 22. For example, a distance between the first interior surface 32A and the second interior surface 32B of the central portion 24 is less than a distance between the first interior surface 32A and the second interior surface 32B of the remainder of the channel 30. In these embodiments, the tapered central portion 24 may give the frame 22 a generally hourglass-shaped profile.

As further depicted in FIGS. 3A and 3B, each of the plurality of cross members 20 may further include a reinforcement member 50 positioned within the cavity 36. In these embodiments, the tapered central portion 24, and more particularly, the first and second interior surfaces 32A, 32B of the tapered central portion 24 of the frame 22 may be used to position the reinforcement member 50 within the cavity 36 of the channel 30. For example, as depicted in FIGS. 3A and 3B, the first and second interior surfaces 32A, 32B of the channel 30 may contact the reinforcement member 50 at the tapered central portion 24, while a space may exist between the reinforcement member 50 and the first and second interior surfaces 32A, 32B of the channel, respectively, throughout the remainder of the channel 30.

Referring now to FIG. 3A, each of the plurality of cross members 20 may further include a foam material 60, such as an expandable adhesive foam, that may be inserted into the cavity 36 defined by the channel 30 in order to secure the reinforcement member 50 within the channel 30 of the frame 22. In these embodiments, the foam material 60 may be inserted into the vacant space within the cavity 36 of the channel 30 that exists between the reinforcement member 50 and the interior surfaces 32 of the channel outside of the tapered central portion 24 of the channel 30. It should be appreciated that, in these embodiments, the foam material 60 described herein with reference to FIGS. 2A and 2B may be similarly used to secure the reinforcement member 50 within the channel 30 of the battery pack frame 10′.

Referring now to FIG. 3B, in some embodiments, the plurality of cross members 20 may further include at least one fastener 52 to fixedly secure the reinforcement member 50 within the cavity 36 of the channel 30 of each of the plurality of cross members 20. In these embodiments, the channel 30 may further include at least one channel hole 33 that extends through the interior surfaces 32 (e.g., first and second interior surfaces 32A, 32B) and exterior surfaces 34 (e.g., in the +/−x-direction as depicted in the coordinate axis of FIG. 3B) of the channel 30. For example, as depicted in FIG. 3B, the channel 30 may include a first channel hole 33A and a second channel hole 33B that may be configured to receive a first fastener 52A and a second fastener 52B, respectively.

In order to secure the reinforcement member 50 within the channel 30, the reinforcement member 50 may further include at least one reinforcement hole 51. In these embodiments, the at least one reinforcement hole 51 may extend through a width of the reinforcement member 50 (e.g., in the +/−x-direction as depicted in the coordinate axis of FIG. 3B), such that the at least one reinforcement hole 51 aligns (e.g., in the +/−y-direction as depicted in the coordinate axis of FIG. 3B) with the at least one channel hole 33 when the reinforcement member 50 is inserted into the channel 30. For example, as depicted in FIG. 3B, a first reinforcement hole 51A may align with the first channel hole 33A of the channel 30, while a second reinforcement hole 51B that may align with the second channel hole 33B of the channel 30.

With the at least one reinforcement hole 51 and the at least one channel hole 33 aligned, the fastener 52 may be inserted through the channel hole 33 and the reinforcement hole 51 to secure the reinforcement member 50 within the channel 30. In the embodiments described herein, the fastener 52 may include a pin, such as a dowel pin, clevis pin, taper pin, spring pin, hitch pins, grooved pin, or any other similar fastener.

Although not depicted, it should be further appreciated that reinforcement member 50 may be fastened to the frame 22 using the fastener 52 at any location without departing from the scope of the present disclosure. For example, the at least one channel hole and the at least one reinforcement hole 51 may be located at the tapered central portion 24 of the frame 22, such that the fastener 52 extends through the tapered central portion 24. Furthermore, it should be understood that each of the plurality of cross members 20 may include any number of fasteners 52 without departing from the scope of the present disclosure.

In view of the foregoing, it should now be understood that embodiments of the present disclosure are directed to battery pack frames including a plurality of cross members that each include a channel, a reinforcement member, and a foam material or fastener for securing the reinforcement member within the channel of the plurality of cross members. The plurality of cross members act to increase the rigidity of the battery pack frame, such that the battery pack frame is capable of withstanding loads caused by vehicle crashes without buckling or undergoing similar deformation.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

What is claimed:

1. A battery pack frame comprising:
a front wall;
a rear wall;
a pair of sidewalls extending between the front wall and the rear wall;
a bottom plate extending beneath the front wall, the rear wall, and the pair of sidewalls; and
a plurality of cross members extending between the pair of sidewalls, each of the plurality of cross members further comprising:
an extruded frame including at least one channel that defines at least one cavity; and
a reinforcement member positioned within the at least one cavity.

2. The battery pack frame of claim 1, further comprising a foam disposed between an interior surface of the at least one cavity and the reinforcement member to secure the reinforcement member within the at least one cavity.

3. The battery pack frame of claim 1, further comprising a fastener that extends through the extruded frame to secure the reinforcement member within the at least one cavity.

4. The battery pack frame of claim 1, wherein the extruded frame includes an upper channel and a lower channel defined by an intermediate wall, the upper channel defining an upper cavity and the lower channel defining a lower cavity.

5. The battery pack frame of claim 1, wherein the reinforcement member is a composite pultrusion reinforcement member.

6. The battery pack frame of claim 2, wherein the foam is an expandable adhesive foam.

7. The battery pack frame of claim 1, wherein the extruded frame further comprises a plurality of locating ribs positioned on an internal surface of the at least one cavity to align the reinforcement member within the at least one cavity.

8. The battery pack frame of claim 1, wherein the extruded frame of each of the plurality of cross members is secured to the bottom plate to couple each of the plurality of cross members to the battery pack frame.

9. The battery pack frame of claim 1, wherein the extruded frame further includes a tapered central portion.

10. The battery pack frame of claim 9, wherein the reinforcement member extends through the tapered central portion of the extruded frame, such that the tapered central portion of the extruded frame positions the reinforcement member within the at least one cavity.
